(19) United States
(12) Patent Application Publication
(10) Pub. No.: US 2026/0027825 A1
(43) Pub. Date: Jan. 29, 2026

(54) RECORDING ELEMENT SUBSTRATE

(71) Applicant: CANON KABUSHIKI KAISHA, Tokyo (JP)

(72) Inventor: YOHEI OSUKI, Chiba (JP)

(21) Appl. No.: 19/259,466

(22) Filed: Jul. 3, 2025

(30) Foreign Application Priority Data
Jul. 26, 2024 (JP) 2024-120769

(51) Int. Cl. B41J 2/14

(52) U.S. Cl. CPC B41J 2/14129; B41J 2/14072; B41J 2/1408

(57) ABSTRACT

Provided is a recording element substrate including an electro-thermal resistor layer provided with an electro-thermal resistor, a wiring layer having an electrical wiring connected to the electro-thermal resistor and a heat dissipation plate disposed beneath the electro-thermal resistor are provided in the same layer, an insulating film for insulating the electro-thermal resistor and the electrical wiring, and a plug provided through the insulating film, the insulating film includes a planarized lower insulating film provided closer to the wiring layer and an upper insulating film provided on the lower insulating film, the upper insulating film is provided on the lower insulating film in a region beneath the electro-thermal resistor at least in the stacking direction, and the ratio of the distance between the electrical wiring and the heat dissipation plate to the thickness of the wiring layer is two or less.

### BACKGROUND

### Field of the Technology

The present disclosure relates to a recording element substrate.

### Description of the Related Art

A recording device of a liquid ejection type (inkjet recording type) performs recording by causing liquid (e.g., ink) ejected from ejection ports provided in a liquid ejection head to adhere to a recording material such as paper. For example, a recording device configured to eject liquid by utilizing bubbling of the liquid caused by thermal energy generated by an electro-thermal conversion element can perform high-quality and high-speed recording.

A liquid ejection head generally includes a recording element substrate, wiring for supplying power and control signals, and a container for storing liquid. The recording element substrate includes a plurality of ejection ports, flow paths in communication with the ejection ports, and a plurality of electro-thermal conversion elements configured to generate thermal energy for ejecting liquid. The electro-thermal conversion element includes an electro-thermal resistor and electrodes for supplying power thereto. The electro-thermal conversion elements are coated with a protective layer made of an insulating material such as silicon nitride, thereby ensuring insulation between the liquid and the electro-thermal conversion elements.

In a liquid ejection head having an electro-thermal conversion element, it is important to maintain a balance between heat accumulation and heat dissipation. If heat accumulates excessively, a phenomenon called “reboil” may occur, in which bubbling happens again after liquid ejection. Meanwhile, excessive heat dissipation increases the time required to supply sufficient heat for bubbling, resulting in a decrease in ejection frequency. In recent years, recording element substrates have increasingly adopted multilayer wiring structures in order to achieve higher density and functionality, and the thickness of insulating films that contribute to heat accumulation has also been increasing. Therefore, there has been a growing demand for the proper dissipation of the thermal energy generated by the electro-thermal conversion elements.

Japanese Patent Laid-Open No. 2016-137705 discloses a configuration in which, in order to improve heat dissipation, a material having high thermal conductivity is provided as a heat dissipation plate beneath the electro-thermal conversion element and in the same layer as a wiring layer.

### SUMMARY

In order to improve the heat dissipation effect, the area of the heat dissipation plate must be increased. However, as shown in Japanese Patent Laid-Open No. 2016-137705, when the heat dissipation plate and the wiring layer are formed in the same layer, increasing the size of the heat dissipation plate reduces the distance between the electrical wiring and the heat dissipation plate, and the coverage of the insulating film formed over the space between the heat dissipation plate and the wiring deteriorates. As a result, voids may form in the insulating layer between the heat dissipation plate and the wiring, or the film quality may deteriorate.

Since the region beneath the electro-thermal resistor is preferably flat, in recording element substrates with a multilayer wiring structure, the electro-thermal resistor is formed on an insulating film planarized for example by chemical mechanical polishing (CMP). In this case, slight recesses on the order of several nanometers may form during the planarization processing in regions of the insulating film where voids have formed or the film quality has deteriorated.

Since a typical semiconductor wiring layer has a film thickness of approximately 100 nm to 1000 nm, small recesses on the order of several nanometers rarely affect the function or reliability of the wiring layer. However, in recording element substrates, the electro-thermal resistor tends to be formed with a reduced film thickness from the viewpoint of power saving, typically in the range of approximately 10 nm to 50 nm. Therefore, even slight recesses on the order of several nanometers in the insulating film may locally reduce the thickness of the electro-thermal resistor, potentially leading to decreased uniformity of heat generation or increased local current density, which may in turn shorten the device's lifespan.

This technology has been made in view of the foregoing problems. This technology is associated with ensuring the flatness beneath the electro-thermal resistor by suppressing slight recesses in the insulating film in a configuration in which a heat dissipation plate is provided in the same layer as the wiring layer beneath the electro-thermal resistor.

The present disclosure provides a recording element substrate comprising a base material and multiple layers stacked on each other on the base material in a stacking direction, the recording element substrate comprising:
an electro-thermal resistor layer provided with an electro-thermal resistor configured to cause liquid stored in a liquid chamber to be ejected;
a wiring layer including an electrical wiring configured to supply the electro-thermal resistor with voltage from an external source and a heat dissipation plate formed in the same layer as the electrical wiring and provided beneath the electro-thermal resistor in the stacking direction;
an insulating film provided between the electro-thermal resistor layer and the wiring layer to insulate between the electro-thermal resistor and the electrical wiring; and
a plug provided through the insulating film to electrically connect the electro-thermal resistor and the electrical wiring,
wherein
the insulating film includes a lower insulating film provided closer to the wiring layer in the stacking direction and having a planarized top portion and an upper insulating film provided on the planarized lower insulating film,
the upper insulating film is provided on the lower insulating film in a region beneath the electro-thermal resistor at least in the stacking direction, and
the ratio of the distance between the electrical wiring and the heat dissipation plate to the thickness of the wiring layer is two or less.

According to the present disclosure, in a configuration in which a heat dissipation plate is provided in the same layer as the wiring layer beneath the electro-thermal resistor, it is possible to suppress slight recesses in the insulating film and ensure the flatness beneath the electro-thermal resistor.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of the structure of a recording device.

FIG. 2 is a perspective view of a recording head.

FIG. 3 is a view of the structure of a recording element substrate.

FIG. 4 is a cross-sectional view of the recording element substrate.

FIG. 5 is an enlarged cross-sectional view of the electro-thermal resistor portion of the recording element substrate according to a first embodiment.

FIGS. 6A to 6F illustrate a method for manufacturing the electro-thermal resistor portion of the recording element substrate according to the first embodiment.

FIG. 7 is an enlarged cross-sectional view of the electro-thermal resistor portion of a conventional recording element substrate.

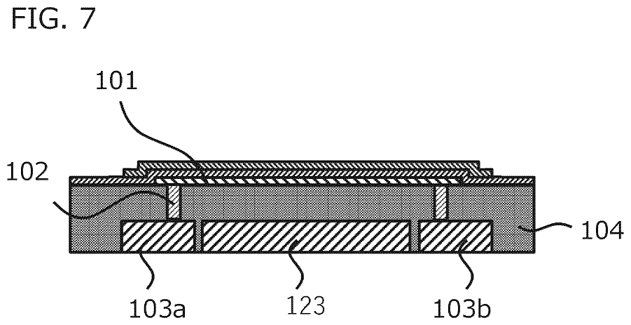

FIGS. 8A to 8F are cross-sectional views of a conventional recording element substrate (with a narrow gap between an electrical wiring and a heat dissipation plate).

FIGS. 9A to 9E are cross-sectional views of a conventional recording element substrate (with a wide gap between an electrical wiring and a heat dissipation plate).

FIG. 10 is a cross-sectional view illustrating how a wiring layer is formed (in comparative example).

FIG. 11 is an enlarged cross-sectional view of the electro-thermal resistor portion of a recording element substrate according to a second embodiment.

FIGS. 12A to 12F illustrate a method for manufacturing the electro-thermal resistor portion of the recording element substrate according to the second embodiment.

### DESCRIPTION OF THE EMBODIMENTS

Preferred embodiments of the present disclosure will now be described in detail, by way of illustration, with reference to the accompanying drawings. Note that, unless otherwise specified, the dimensions, materials, shapes, and relative arrangements of the components in the following embodiments are not intended to limit the scope of the present disclosure. Unless otherwise specified, the materials, shapes, and other characteristics of the components described once in the following remain the same throughout the subsequent description. Well-known or known techniques in the art can be applied to configurations and steps that are not specifically illustrated or described. In addition, the present disclosure is not limited to these embodiments, and not all combinations of the features in the following embodiment are essential to the solution according to the present disclosure.

### First Embodiment

### Structure of Recording Device

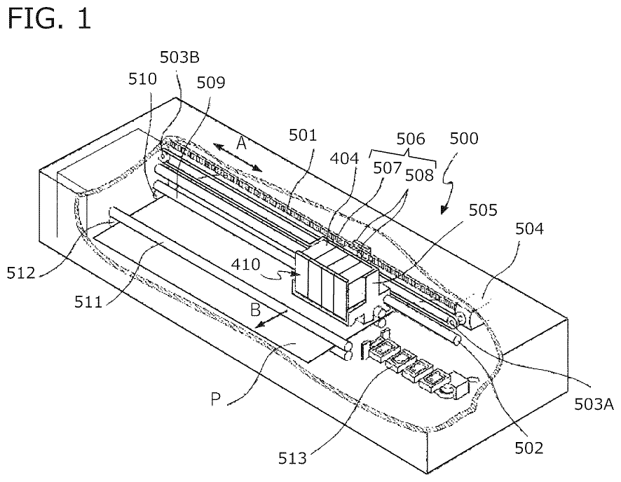

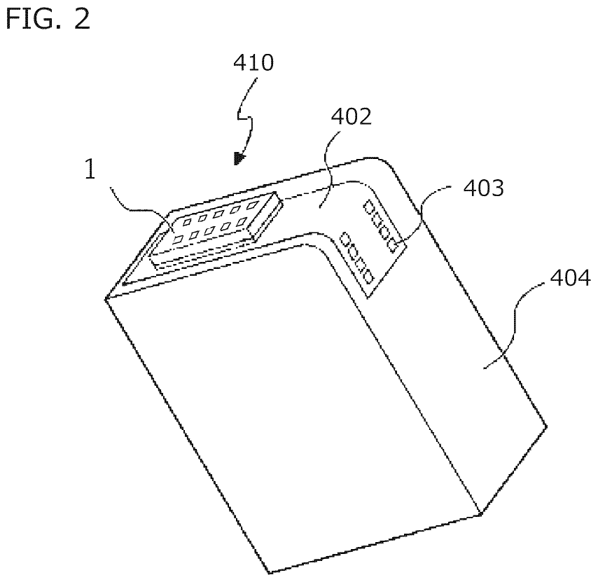

First, referring to FIGS. 1 and 2, a recording device (liquid ejection device) having a recording head (liquid ejection head) according to a first embodiment will be described. Herein, an ink-jet recording device configured to eject liquid, such as ink, to a recording medium for recording will be described as an example. In the recording device, the recording head configured to eject liquid for recording corresponds to a liquid ejection head. FIG. 1 is a partly cutaway, schematic view of the structure of the recording device having the recording head. FIG. 2 is a perspective view of a head unit.

The recording device 500 includes a carriage 505 to which the head unit 410 can be detachably attached. The carriage 505 is mounted on an endless belt 501 which is stretched around a drive pulley 503A and a driven pulley 503B. The carriage 505 is slidably provided on a guide shaft 502 provided in parallel with the extending direction of the belt 501. When the drive pulley 503A, which uses a carriage motor 504 as a drive source, rotates, the belt 501 rotates, and the carriage 505 moves in the direction of arrow A while being supported by the guide shaft 502. Accordingly, the carriage 505 can reciprocate in the direction of arrow A in accordance with the rotational direction of the drive pulley 503A.

The recording device 500 includes an encoder sensor 508. The encoder sensor 508 detects slits in a linear scale 507 that extends in the direction A. A control unit in the recording device 500 detects the position of the carriage 505 in the direction A on the basis of the detection result of the linear scale 507 by the encoder sensor 508. The linear scale 507 and the encoder sensor 508 together can be regarded as position detection means 506.

The recording device 500 includes a first pair of conveyance rollers 509 and 510 and a second pair of conveyance rollers 511 and 512. The first and second pairs of conveyance rollers are rotated by a conveyance motor to convey a recording medium P in the direction of arrow B. The first pair of conveyance rollers 509 and 510 is located on the upstream side in the Y-direction, which is the conveying direction of the recording medium P, and the second pair of conveyance rollers 511 and 512 is located on the downstream side in the Y-direction. In the direction B, the first pair of conveyance rollers 509 and 510 and the second pair of conveyance rollers 511 and 512 are positioned to sandwich a region in which liquid is ejected by the head unit 410. The first and second pairs of conveyance rollers convey the recording medium P while nipping it, thereby maintaining the smoothness at the position facing the recording head in the head unit 410.

Then, the control unit of the recording device 500 performs a recording operation by ejecting liquid from the recording head of the head unit 410 onto the recording medium P in accordance with the recording data, while driving the carriage motor 504. At the time, the control unit drives the carriage motor 504 on the basis of the detection result by the encoder sensor 508. As a result, one band of an image is recorded on the recording medium P. Thereafter, the control unit performs a conveyance operation by driving the conveyance motor to convey the recording medium P in the direction of arrow B by a distance corresponding to one band. The recording device 500 forms a recorded image on the recording medium P by repeating the recording operation and the conveyance operation alternately in this manner.

The recording device 500 also includes a recovery unit 513 for performing maintenance on the recording head of the head unit 410 at a home position at one end in the direction A. The recovery unit 513 includes a cap member for protecting the recording head and a pump configured to generate negative pressure in the cap member by suction.

In the present embodiment, four head units 410 can be mounted on the carriage 505. The head units 410 are each capable of ejecting cyan, magenta, yellow, and black ink. As shown in FIG. 2, each head unit 410 includes a tank 404 that stores liquid therein and a recording head 1 configured to eject the liquid stored in the tank 404. The head unit 410 also includes a wiring tape 402 for supplying recording data, power, and the like to the recording head 1. The wiring tape 402 is provided with contacts 403 for electrically connecting the head unit 410 to the recording device 500 when the head unit 410 is mounted on the carriage 505.

Note that, while the head unit 410 in which the tank 404 and the recording head 1 are integrated is used in the present embodiment, the present disclosure is not limited to this configuration. More specifically, the tank 404 and the recording head 1 may be provided as separate components. Specifically, the recording head 1 may be provided on the carriage 505, and the liquid may be supplied to the recording head 1 from the tank 404 that is detachably provided in the recording device 500, via a tube, for example. In this case, a separate recording head 1 may be provided for each color, or a single recording head capable of ejecting all four types of liquid may be provided. Note that the number of colors of liquid used in the recording device 500 and the types of liquid to be ejected are not limited to the above. More specifically, the number of colors of liquid may be only one or may be two, three, or five or more. The types of liquid may include, for example, treatment liquids for performing prescribed types of processing on the recording medium P other than the ink.

### Description of Recording Element Substrate

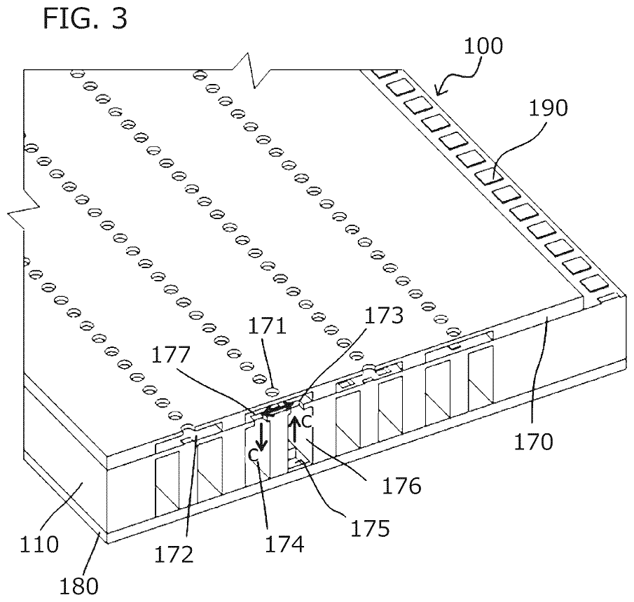

The structure of the recording element substrate 100 will be described. FIG. 3 is a schematic perspective view of the structure of the recording element substrate 100 according to the embodiment. The recording element substrate 100 includes a substrate 110, serving as a base material, in which a liquid supply path 176 for supplying liquid to the liquid chamber 172 and a liquid recovery path 174 for recovering liquid from the liquid chamber 172 are formed. A nozzle member 170 having rows of ejection ports 171 for ejecting liquid is provided on one surface of the substrate 110. A cover plate 180 is formed on the surface on the other side of the substrate 110.

The liquid supply path 176 and the liquid recovery path 174 extend in the direction in which the rows of ejection ports extend in the nozzle member 170. On one surface of the substrate 110, a plurality of supply ports 173 in communication with the liquid supply path 176 are arranged in the direction in which the rows of ejection ports extend. On the side of this surface of the substrate 110, a plurality of recovery ports 177 in communication with the liquid recovery path 174 are arranged in the direction in which the rows of ejection ports extend.

On the side of this surface of the substrate 110, a thermal action portion for causing bubbles in the liquid by thermal energy is formed at a position corresponding to the ejection port 171. The thermal action portion includes an electro-thermal resistor 101 (also referred to as a “recording element,” “electro-thermal conversion element,” or “electro-thermal resistive element”) configured to cause the liquid to be ejected for recording and an electrode 301 that also serves as an anti-cavitation layer configured to protect the electro-thermal resistor 101. The thermal action portion is located inside the liquid chamber 172 formed in the nozzle member.

A terminal 190 is formed on the side of this surface of the substrate 110 and is electrically connected to the electro-thermal resistor 101 via an electrical wiring (not shown) provided on the substrate 110. Accordingly, the electro-thermal resistor 101 generates heat in response to a pulse signal input via an external wiring board (not shown), thereby boiling the liquid in the liquid chamber 172. The liquid is ejected from the ejection port 171 by the force of bubbles generated by the boiling.

The cover plate 180 is provided with an opening 175 in communication with the liquid supply path 176 and an opening (not shown) in communication with the liquid recovery path 174. The liquid is supplied to the recording head through the opening 175, and the liquid is recovered from the recording head through the opening in communication with the liquid recovery path 174. Accordingly, in the recording element substrate 100, the liquid is supplied to the liquid chamber 172 through the opening 175, the liquid supply path 176, and the supply port 173. The liquid supplied to the liquid chamber 172 is recovered through the recovery port 177, the liquid recovery path 174, and an opening in communication with the liquid recovery path 174.

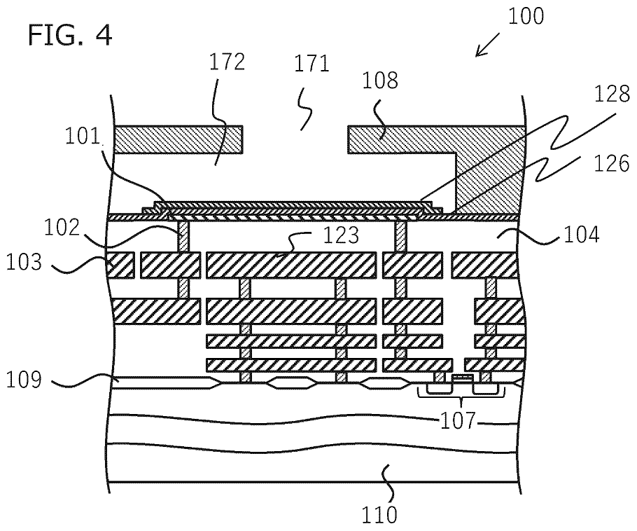

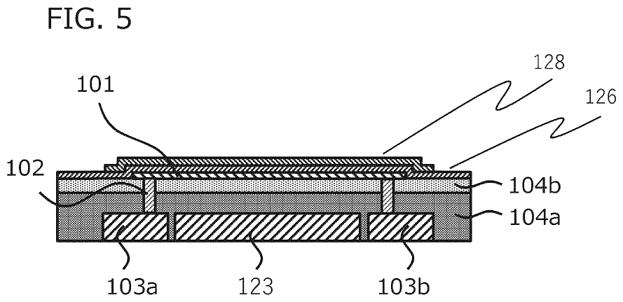

FIG. 4 is a schematic cross-sectional view of the recording element substrate 100. FIG. 5 is an enlarged schematic view of the peripheral region of the electro-thermal resistor 101. The recording element substrate 100 includes the substrate 110, and a plurality of electrical wirings 103, plugs 102 for electrically connecting the electrical wirings 103, and an insulating film 104 for electrically isolating the electrical wirings 103, all of which are stacked on the substrate 110. It should be noted that terms such as “upper/lower” and “upper layer/lower layer” used in the description of the present disclosure to indicate the vertical stacking direction of multiple layers correspond to the vertical relationship in the drawings. However, such expressions are provided merely for convenience and do not define the actual orientation of the recording element substrate 100 in the vertical direction. In the present disclosure, the term the upper layer refers to an upper layer in the stacking direction when the substrate 110 as a substrate is the lowermost layer and multiple layers are stacked in the direction.

As shown in FIG. 5, the electro-thermal resistor 101 is electrically connected to electrical lines 103a and 103b by plugs 102 and converts supplied desired voltage into heat. The electrical wirings 103a and 103b are provided in the wiring layer. In the wiring layer, a heat dissipation plate 123, which will be described later, is provided in the same layer as the electrical wirings 103a and 103b. The electro-thermal resistor 101 heats the liquid located above it and causes film boiling, so that the liquid is ejected from the ejection port 171 formed in the nozzle member 108. Heat generated during ejection is dissipated to the side of the heat dissipation plate 123. The heat accumulated in the heat dissipation plate 123 is conducted through the electrical wirings 103 and the plugs 102, and is eventually absorbed by the substrate 110, which serves as a silicon base material.

If the heat dissipation is insufficient, heat is accumulated every time the ejection is performed. In order to avoid the influence of the heat during the next ejection, it is necessary to wait until the temperature around the electro-thermal resistor becomes equal to that before the ejection, and if the heat dissipation is insufficient, the ejection frequency decreases. Therefore, it is effective to use a material having a high thermal conductivity for the heat dissipation plate 123, and a material used for the electrical wiring 103, for example, AlCu or AlSi can be used. The dissipation effect increases as the size of the heat dissipation plate increases. Accordingly, it is also possible to form the electrical wiring 103 and the heat dissipation plate 123 in the same layer during film formation to constitute a single layer. In this case, the manufacturing steps may be simplified as compared with the case of providing the electrical wiring 103 and the heat dissipation plate 123 separately.

### Method for Manufacturing Recording Element Substrate

A method for manufacturing the recording element substrate 100 of the present disclosure will be described with reference to FIG. 4. First, a drive circuit 107 including transistors and the like, and a field oxide film 109 are formed on the substrate 110 serving as a base material. Since these components can be formed by general semiconductor manufacturing methods, detailed description thereof will not be provided. The insulating film 104 made of a SiO film with a thickness of about 300 nm to 1000 nm is then formed thereon, which serves as an insulating layer. At the time, in order to obtain more uniform liquid ejection characteristics, high precision is required with respect to variations in bubbling and resistance values. Therefore, the base (lower) region of the electro-thermal resistor layer (which will be described later) is preferably flat. Accordingly, in this configuration, the lower layers of the electrical wirings and the electro-thermal resistor layer are planarized. For the planarization, chemical mechanical polishing (CMP), for example, may be used. The thickness of the insulating film polished by the CMP is about 150 nm to 500 nm.

Next, in order to connect the drive circuit 107 and the electrical wiring 103, a through-hole is formed so as to penetrate the planarized insulating film 104, and the plug 102 is embedded therein. Tungsten (W), for example, may be used as the material for the plug. The electrical wiring 103 of a material such as AlCu or AlSi is formed thereon with a thickness of about 400 nm to 1000 nm and is then patterned. A multilayer wiring structure is formed by repeatedly forming the insulating film 104, forming through-holes, embedding the plugs 102, forming the electrical wirings 103, and patterning the electrical wirings 103. At the time, the thickness of the insulating film 104 in each layer of the multilayer structure is preferably increased in accordance with the thickness of the lower electrical wiring 103. For example, when the lower electrical wiring 103 is formed with a thickness of 1000 nm, the overlying insulating film 104 has preferably a thickness of 1000 nm or more after the planarization.

Next, the insulating film 104 is deposited on the uppermost electrical wiring 103, that is, above the wiring layer, then through-holes are formed, the plugs 102 are embedded, and the layer of the electro-thermal resistor 101 is deposited and patterned. A material with high specific resistance such as TaSiN is preferably used for the electro-thermal resistor, and the film thickness can be, for example, about 10 nm to 50 nm. A protective film 126 and an anti-cavitation film 128 may be formed on the electro-thermal resistor 101. The protective film 126 can be formed of SiN with a thickness of about 200 nm to 300 nm, and the anti-cavitation film 128 can be formed of a material such as Ta or Ir with a thickness of about 200 nm to 300 nm.

### Problem Associated With Conventional Methods for Manufacturing Recording Element Substrate

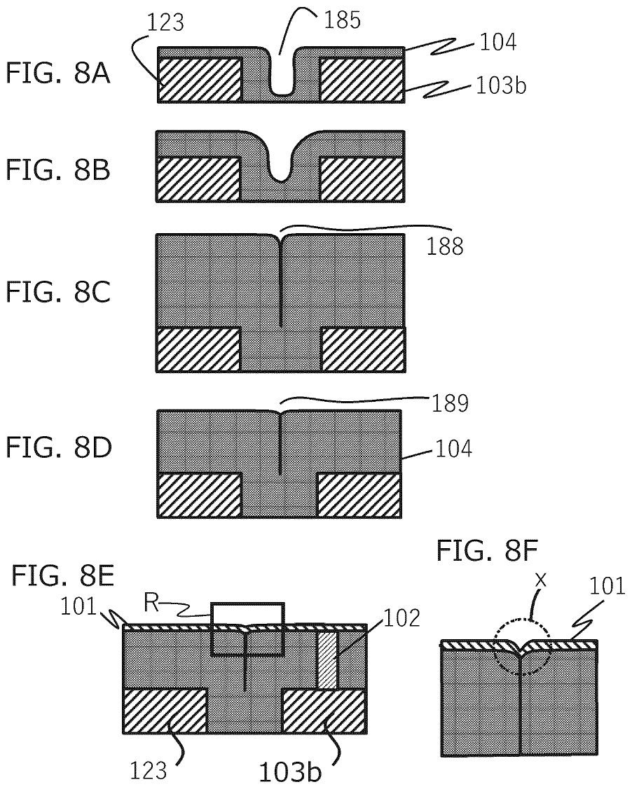

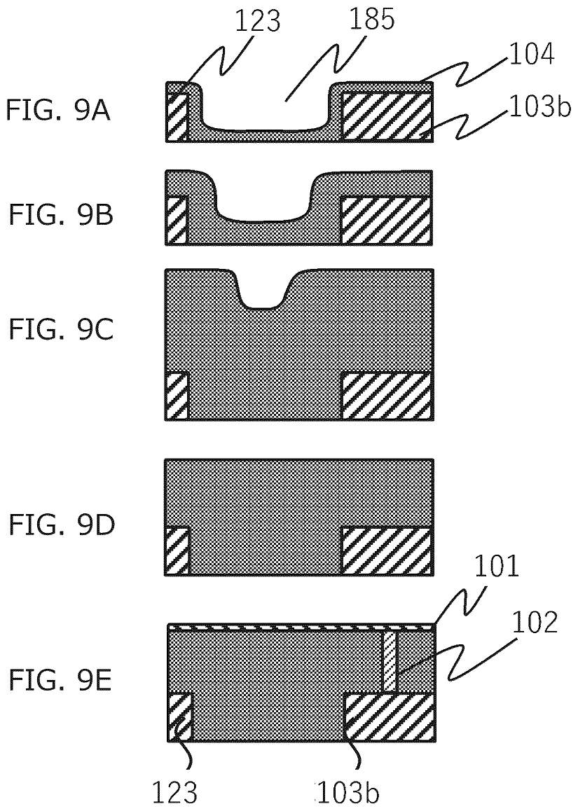

Problems associated with conventional methods for manufacturing the recording element substrate 100 will be described with reference to FIGS. 8A to 8F and FIGS. 9A to 9E. Here, in particular, the steps of depositing/patterning the electrical wiring 103, forming the insulating film 104 and a through hole, embedding the plug 102, and forming and patterning the electro-thermal resistor 101 will be described.

FIGS. 9A to 9E show the case in which the size of the heat dissipation plate 123 is small and the distance between the electrical wiring 103b and the heat dissipation plate 123 is sufficient. FIG. 9A shows an initial stage of forming the insulating film 104 on the layer provided with the electrical wiring 103b and the heat dissipation plate 123. Since the insulating film 104 is deposited from the bottom side, or on the side surfaces of the electrical wiring 103 and the heat dissipation plate 123, a gap 185 exists in the initial stage. Thereafter, the gap 185 gradually decreases as the deposition of the insulating film 104 progresses as shown in FIGS. 9B and 9C. In FIG. 9D, the gap 185 disappears. Then, in FIG. 9E, a through hole is formed, the plug 102 is embedded, and the electro-thermal resistor 101 is formed.

In this way, the insulating film 104 formed on the electrical wiring 103 is deposited from the lower side at the flat portion between the electrical wiring 103 and the heat dissipation plate 123, and along the sidewalls of the electrical wiring 103 and the heat dissipation plate 123. At the time, if the distance between the electrical wiring 103 and the heat dissipation plate 123 is sufficient, deposition from below is dominant in the central portion between the electrical wiring 103 and the heat dissipation plate 123. The upper surface of the insulating film 104 can be planarized by forming the insulating film 104 to a thickness about twice as thick as the required thickness, followed by planarizing by CMP. For example, if the electrical wiring 103 has a film thickness of 1000 nm, the insulating film 104 is deposited to a thickness of about 2000 nm to 3000 nm, and is then polished and planarized by CMP to have a thickness of about 1000 nm to 1500 nm. As a result, the layer of the electro-thermal resistor 101 formed on the planarized insulating film 104 can be formed flat.

FIGS. 8A to 8F show the case in which the size of the heat dissipation plate 123 is large, and the space between the electrical wiring 103b and the heat dissipation plate 123 is narrow. FIG. 8A shows the initial stage of forming the insulating film 104 on the layer provided with the electrical wiring 103b and the heat dissipation plate 123. Since the insulating film 104 is deposited from the bottom surface or on the side surfaces of the electrical wiring 103 and the heat dissipation plate 123, a gap 185 exists. Thereafter, in FIG. 8B, as the deposition of the insulating film 104 progresses, the gap 185 becomes smaller.

Here, unlike FIGS. 9A to 9E, in FIGS. 8A to 8F, deposition from the side walls of the electrical wiring 103 and the heat dissipation plate 123 is dominant in the central portion between the electrical wiring 103 and the heat dissipation plate 123. As the deposition progresses from the side (sidewall side) in this way, a void 188 may occur between the electrical wiring 103b and the heat dissipation plate 123, as shown in FIG. 8C. Also, in the area with the void 188, the film quality tends to deteriorate. Particularly, if the ratio of the distance between the electrical wiring 103b and the heat dissipation plate 123 to the film thickness of the wiring layer becomes 2 or less, the likelihood of occurrence of void 188 increases. In the present disclosure, the void 188 refers to a small cavity formed during the formation of the insulating film 104, which is a region where embedding of the insulating material is insufficient.

In FIG. 8C, the insulating film 104 is deposited to about twice the required thickness, and is then polished and planarized by CMP, as shown in FIG. 8D, but a slight recess 189 is locally generated at the portion of the void 188 during polishing. As shown in FIG. 8E, the electro-thermal resistor 101 formed on the insulating film 104 with the recess 189 is typically a very thin film having a thickness of about at least 10 nm and not more than 50 nm and affected by even the slight recess in the underlying layer. As a result, the layer of the electro-thermal resistor 101 is not formed flat and becomes locally thinner. FIG. 8F is an enlarged view of the region R in FIG. 8E. In the encircled area X, the electro-thermal resistor 101 formed along the slight recess is thin.

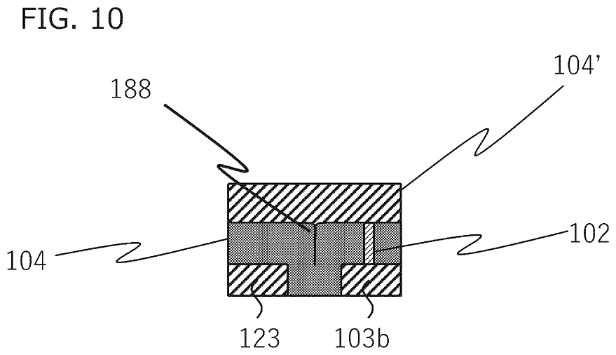

In this manner, when current is applied to the electro-thermal resistor 101 having the locally thinned region, the uniformity of heat generation may decrease and the current density may increase locally, possibly resulting in a shorter lifespan. FIG. 10 shows the case in which a general wiring layer 104′ is formed on the insulating film 104 by way of illustration. If the film thickness is 400 nm or more as in the case of the wiring layer 104′, the influence of the slight recess is negligible. The slight recess is gradually leveled as the deposition of the upper wiring layer 104′ progresses, and the surface becomes nearly flat at the top of the wiring layer 104′.

### Manufacturing Method According to Present Embodiment

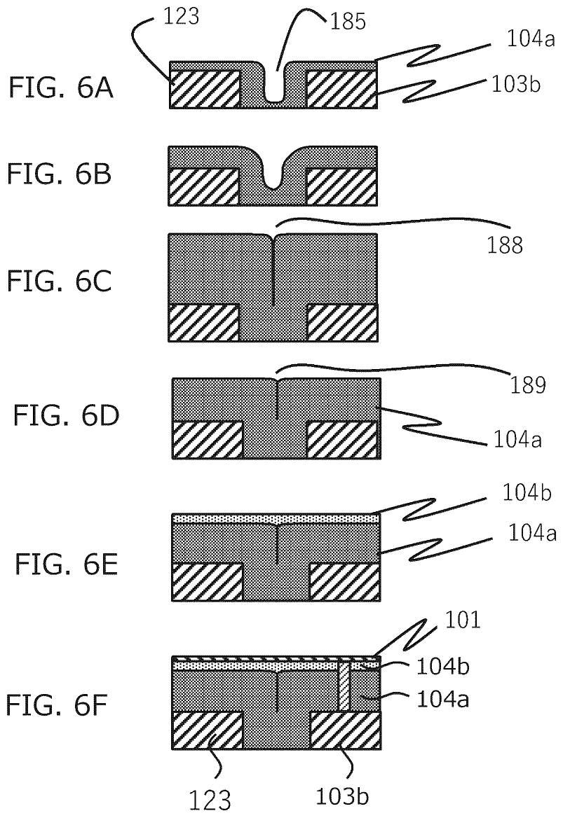

Referring to FIGS. 6A to 6F, the recording element substrate 100 according to the present embodiment will be described. The insulating film 104 in FIGS. 6A to 6F includes a lower insulating film 104a provided in a layer closer to the electrical wiring 103 in the stacking direction, and an upper insulating film 104b provided in a layer closer to the electro-thermal resistor 101 and away from the wiring layer in the stacking direction. FIGS. 6A to 6C correspond to the process shown in FIGS. 8A and 8B. In the step of planarizing the lower insulating film 104a in FIG. 6D, the film thickness of the lower insulating film 104a is made thinner than that in the step of planarizing the insulating film 104 in the conventional example in FIG. 8D. For example, the film thickness of the lower insulating film 104a at the time of film formation before CMP may be made thin, or the lower insulating film 104a may be made thin by extending the time for the CMP. The lower insulating film 104a can be formed of a SiO film with a thickness of about 1000 nm. At the point in FIG. 6D, a slight recess 189 generated during the CMP exists in the lower insulating film 104a.

In FIG. 6E, an upper insulating film 104b is formed on the lower insulating film 104a to cap the slight recess 189. The upper insulating film 104b can be formed of a SiO film having a thickness of about 100 nm to 1000 nm. At the time, the insulating film 104 shown in FIG. 8D is formed to have approximately the same thickness as the total film thickness of the lower insulating film 104a and the upper insulating film 104b shown in FIG. 6E. The same material is used for both the lower insulating film 104a and the upper insulating film 104b, so that functionality equivalent to that of the conventional insulating film 104 is ensured.

From the viewpoint of eliminating the influence of the recess 189, the thickness of the upper insulating film 104b is preferably about 100 nm to 1000 nm at the time of film formation. However, the present invention is not limited to this as far as the upper insulating film 104b can be planarized. For example, the upper insulating film 104b may initially be formed with a thickness of 300 nm and may subsequently be processed to have a thickness of 100 nm or less by CMP.

Since the influence of the recess 189 can be reduced by providing the upper insulating film 104b, the performance of the recording head can be improved as compared to the conventional configurations.

The thickness of the upper insulating film 104b can be changed depending on the size of the recess. For example, assume that when an insulating film with a thickness of 400 nm is required, the lower insulating film 104a is formed with a thickness of 350 nm and the upper insulating film 104b is formed with a thickness of 50 nm, but the influence of the recess 189 cannot be completely eliminated. In this case, the influence of the recess 189 can be eliminated by forming the lower insulating film 104a and the upper insulating film 104b each with a thickness of 200 nm.

According to this manufacturing method, the slight recess 189 in the lower insulating film 104a is gradually leveled and planarized in the process of forming the upper insulating film 104b. The upper insulating film 104b is preferably formed thicker than the electro-thermal resistor 101 formed thereon. Further, the upper insulating film 104b may be planarized, but the functionality may be ensured without planarizing.

### Method for Evaluating Planarization

Whether the lower insulating film 104a is planarized can be evaluated by analyzing a cross-section of the recording element substrate 100. For example, the recording element substrate 100 may be processed using a focused ion beam (FIB) device, and detection may be performed using a transmission electron microscope (TEM). Although the lower insulating film 104a and the upper insulating film 104b are separately formed in this embodiment, the film interface between the separately formed films can be suitably analyzed by a transmission electron microscope.

As described above, conventionally, when the width in the in-plane direction between the electrical wiring 103 and the heat dissipation plate 123 in the same layer is relatively small and voids are formed in the insulating film 104, the electro-thermal resistor 101 may be partially thinned due to the influence of the slight recess 189 in the insulating film. As a result, the uniformity of heat generation can decrease or the current density can locally increase, possibly resulting in a shorter lifespan. Therefore, in the recording element substrate 100 obtained according to this embodiment, the upper insulating film 104b is provided on the lower insulating film 104a to ensure the flatness beneath the electro-thermal resistor 101. As a result, a recording head having high functionality and reliability can be provided.

### Second Embodiment

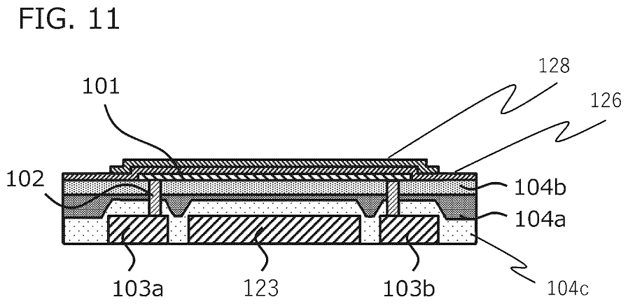

Now, a second embodiment will be described with reference to the accompanying drawings. FIG. 11 is an enlarged schematic cross-sectional view of the peripheral region of the electro-thermal resistor 101 of the recording element substrate 100 in the second embodiment. The lower insulating film 104a is provided beneath the upper insulating film 104b, and a base insulating film 104c formed by high-density plasma CVD is formed between the lower insulating film 104a and the electrical wiring 103.

The base insulating film 104c is used to improve the embedding property of the interlayer insulating films. More specifically, the presence of the base insulating film 104c facilitates film formation on stepped portions such as groove regions. In high-density plasma CVD, film formation proceeds more slowly at protrusions and corners than in other regions, and as a result, the shapes of the protrusions and corners are smoothed. As a result, the lower insulating film 104a can be formed on the base insulating film 104c with fewer voids.

For example, a SiO film can be used as the material of the base insulating film 104c. The SiO film formed by high-density plasma CVD is called HDP-SiO. The presence of the HDP-SiO film beneath the lower insulating film 104a tends to improve coverage in the region where the distance between the electrical wiring 103b and the heat dissipation plate 123 is small. Even if the distance between the electrical wiring 103b and the heat dissipation plate 123 is small and the slight recess 189 tends to be formed when the lower insulating film 104a is deposited and planarized, the condition of the slight recess 189 tends to improve.

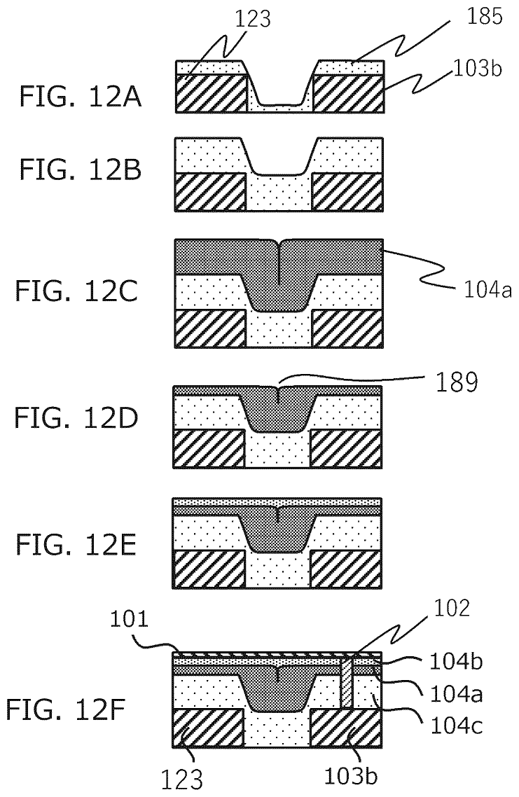

FIGS. 12A to 12F illustrate a method for manufacturing the recording element substrate 100 according to the second embodiment. For example, when the electrical wiring 103b and the heat dissipation plate 123 in the same layer are formed of AlCu with a thickness of 1000 nm, the base insulating film 104c is formed on the electrical wiring 103 with a thickness of about 1000 nm using HDP-SiO, as shown in FIGS. 12A and 12B. Then, as shown in FIG. 12C, a SiO film is formed with a thickness of 1000 nm to 3000 nm by plasma CVD as the lower insulating film 104a on the base insulating film 104c. Then, as shown in FIG. 12D, the lower insulating film 104a is planarized by polishing, such as by CMP. At the time, the recess 189 exists in the lower insulating film 104a.

Subsequently, as shown in FIG. 12E, a SiO film to serve as the upper insulating film 104b is formed by plasma CVD with a thickness of about 100 nm to 1000 nm on the planarized lower insulating film 104a. Next, as shown in FIG. 12F, a through hole is formed and the plug 102 is embedded. Subsequently, the electro-thermal resistor 101 is formed and patterned. The electro-thermal resistor 101 is formed from a high-resistivity material such as TaSiN (tantalum silicon nitride) with a thickness of about 10 nm to 50 nm. The protective film 126 and the anti-cavitation film 128 as shown in FIG. 11 may be formed on the electro-thermal resistor 101. The protective film can be formed from a material such as SiN with a thickness of about 200 nm to 300 nm, and the anti-cavitation film can be formed from a material such as Ta or Ir with a thickness of about 200 nm to 300 nm.

As in the foregoing, the recording element substrate 100 obtained according to the present embodiment also allows for securing planarity beneath the electro-thermal resistor 101, similarly to the first embodiment, so that a recording head with high functionality and reliability can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-120769, filed on Jul. 26, 2024, which is hereby incorporated by reference wherein in its entirety.

What is claimed is:

1. A recording element substrate comprising a base material and multiple layers stacked on each other on the base material in a stacking direction, the recording element substrate comprising:
an electro-thermal resistor layer provided with an electro-thermal resistor configured to cause liquid stored in a liquid chamber to be ejected;
a wiring layer including an electrical wiring configured to supply the electro-thermal resistor with voltage from an external source and a heat dissipation plate formed in the same layer as the electrical wiring and provided beneath the electro-thermal resistor in the stacking direction;
an insulating film provided between the electro-thermal resistor layer and the wiring layer to insulate between the electro-thermal resistor and the electrical wiring; and
a plug provided through the insulating film to electrically connect the electro-thermal resistor and the electrical wiring,
wherein
the insulating film includes a lower insulating film provided closer to the wiring layer in the stacking direction and having a planarized top portion and an upper insulating film provided on the planarized lower insulating film,
the upper insulating film is provided on the lower insulating film in a region beneath the electro-thermal resistor at least in the stacking direction, and
the ratio of the distance between the electrical wiring and the heat dissipation plate to the thickness of the wiring layer is two or less.

2. The recording element substrate according to claim 1, wherein the electro-thermal resistor is formed with a thickness of 50 nm or less.

3. The recording element substrate according to claim 1, wherein the electro-thermal resistor comprises TaSiN as a material.

4. The recording element substrate according to claim 1, wherein the insulating film comprises SiO as a material.

5. The recording element substrate according to claim 1, further comprising a base insulating film deposited between the lower insulating film and the wiring layer by high-density plasma CVD.

6. The recording element substrate according to claim 1, wherein the upper insulating film is planarized.

7. The recording element substrate according to claim 1, wherein the upper insulating film is formed without planarization.

8. The recording element substrate according to claim 1, wherein the upper insulating film has a greater thickness than that of the electro-thermal resistor layer.
